(19) United States
(12) Patent Application Publication
(10) Pub. No.: US 2015/0281337 A1
(43) Pub. Date: Oct. 1, 2015

(54) OPEN, EXTENSIBLE, SCALABLE, METHOD AND SYSTEM WHICH DELIVERS STATUS MONITORING AND SOFTWARE UPGRADES TO HETEROGENEOUS DEVICES VIA A COMMON USER INTERFACE

(71) Applicant: BASIC6, INC., Westport, CT (US)

(72) Inventors: Edward SAMSON, Weston, CT (US); Magnus WENNEMYR, Amherst, MA (US)

(21) Appl. No.: 14/671,694

(22) Filed: Mar. 27, 2015

Related U.S. Application Data
(60) Provisional application No. 61/972,754, filed on Mar. 31, 2014.

(51) Int. Cl. H04L 29/08; G06F 9/48

(52) U.S. Cl. CPC H04L 67/10; G06F 9/4881

(57) ABSTRACT

A device having a processor and at least one apparatus for the device to interact with the environment in which the device is located. The at least one apparatus exchanges signal with the processor. Memory associated with the processor has a first program or programs for operating the processor and application-related activities, and a second program for performing operations related to the state of the device. A network connection connects the device to a network so that operations relating to the state of the device can be remotely performed using the network. A method for communicating with the device includes accessing in its memory a program for interacting with the processor, the program performing operations related to the state of the device; and sending tasks relating to the state of the device to the processor so that the operation of the device or apparatus interacting with the environment is managed.

This application claims priority from and the benefit of provisional patent application Ser. No. 61/972,754 filed on Mar. 31, 2014, which is incorporated herein by reference, in its entirety, for all purposes.

### BACKGROUND OF THE DISCLOSURE

1. Field of the Disclosure

The present disclosure relates to among other things, the Internet of Things (IoT). More specifically, it relates to the management of heterogeneous devices, often with heterogeneous operating environments and software. The IoT is essentially the set of connectable and identifiable electronic devices that are increasingly installed in our surroundings.

2. Description of the Related Art

In earlier times, small microcontroller-based devices were considerably less capable than some modern lines of devices. Once in place, devices have been left to operate without interference or communication beyond the local deployment site. That is changing with the Internet of Things (IoT).

With the IoT “smart” devices have proliferated; devices capable of a greater range of functionality and communication. Focus in this burgeoning field is at this time largely on the “Application” side (your door at home opens, you get a text). The way such devices operate is typically with a microcontroller (MCU)-based program that collects data about and controls its environment via sensors. Smart devices include WiFi or other communication modes, and sometimes even an external microprocessor (MPU) running full-fledged operating systems that greatly extend the device's capabilities. In such cases, the application running on the MCU may call libraries on the MPU to process information to inform device control decisions, and the application may send data back targeting a customer's data store.

### SUMMARY OF THE DISCLOSURE

Smarter devices imply a need for status monitoring and maintenance. It is this latter need that is addressed by the current disclosure. The underlying concept is that for a device, no matter where it is located, as long as it is reachable and addressable over the Internet, a system is provided whereby status monitoring, generic (Application-independent) control and configuration, and software upgrades, can be delivered to heterogeneous device types in a generic fashion; in other words via a common user interface. Some of the reasons for changes to application software on a device include bug fixes, feature enhancements, and reactions to communication protocol changes. Optionally, Application-level control and configuration can be delivered to heterogeneous device types via the same mechanisms.

The disclosure is directed to a device comprising a processor; at least one interface for the device to interact with apparatus in the environment in which the device is located, the at least one interface being connected to the processor to send a signal to or receive signals from the processor; memory associated with the processor having a first program or programs for operating the processor and carrying out Application related activities; a second program for performing additional operations related to the state of the device; and a network connection for connecting the device to a network so that operations relating to the state of the device can be remotely performed using the network.

The processor can be a microprocessor, and communication with the device via the network is with the microprocessor. The processor can be a microcontroller, and communication with the device via the network is with the microcontroller. If the device includes both a microprocessor and a microcontroller, communication is generally with the microprocessor.

The device can comprise a microprocessor for running the first program; and a microcontroller for running the second program. In other devices, a microcontroller may itself run all programs. In yet others, a microprocessor may run all programs. In the special case when control can be exercised in a secure manner without the second program residing on a device, as in the case of a desktop-based controlling interface managing devices within a local area network, the second program may reside not on the device but within the controlling interface.

The second program may be considered to be comprised of a generic portion, and a number of extensions, “Plugins”, which extend the functionality of the generic portion.

The device comprises at least one interface for connection to at least one of a sensor, an actuator and a transducer.

The second program facilitates an operation selected from the group consisting of configuring a program in the memory, replacing a program in the memory, changing the state of the processor, sending updates responsive to communication protocol changes, recording access credentials for interacting with the device, and changing the state of device components peripheral to the processor. Such peripheral device components may include but are not limited to communication-related hardware, actuators, sensors, transducers, other data sources, other microprocessors or microcontrollers, or a mesh of devices not directly connected to the platform but connected to the platform-connected device.

The second program also manages the communication channel over which status is reported, and control is sent, to and from the device, for the express purpose of providing a reliable means of accessing the device interface remotely.

The disclosure is also directed to a system for interacting with the device comprising a task input subsystem for a user to input a task to be performed on the device; a task translation subsystem for translating the task into a language usable by the device; and a communications module for the system to use in communicating the task to the device via the network.

The disclosure is further directed to a device having a processor and at least one interface for the device to interact with apparatus in the environment in which the device is located, the at least one interface being connected to the processor to send a signal to or receive signals from the processor; comprising accessing in the memory of the device a program for interacting with the processor, the program performing operations related to the state of the device; and sending tasks relating to the state of the device to the processor so that the operation of the device is managed.

The design of the disclosure is structured so that the method can be adapted to heterogeneous devices and device configurations by adding, subtracting, or modifying “Plugins” that interact with the generic portion of the second program to constitute the complete device-resident portion of the system, without requiring changes to the generic, “core”, portion of the second program. This extensibility lends the ability for a user skilled in the art to customize the solution with relative ease to carry out any actions that could be carried out absent the system disclosed herein, while leveraging the channel of communication established by the system for device control and status reporting.

The system for interacting with the device forms a task input subsystem for a user to input a task and is designed so that customized signals corresponding to inputs useable by Plugins residing on the device can be readily constructed without modification to the generic portion of the solution.

The invention is considered “open” as Plugins may be constructed so as to transport application data from the device to any networked endpoint, including other cloud platforms, lending flexibility to the system.

The cloud platform and Core device functionality is constructed so as to make the System as a whole highly scalable.

The method can further comprise installing or replacing programs in the memory of the device, including components relating to some or all of the method steps.

Preferably, the device includes a network communication module; and the method includes sending of tasks to be performed using a network to which the communications module is connected.

### BRIEF DESCRIPTION OF THE DRAWINGS

FIG. 1 is a block diagram of a system for managing a smart device.

FIG. 2 illustrates the components of a system in accordance with the disclosed embodiment.

FIG. 3 illustrates an auto connect feature that is used when a lack of communication is detected.

FIG. 4 is a high level block diagram of the various subsystems of the system of FIG. 1.

FIG. 5 is a high level block diagram of the plugin-oriented device agent architecture.

FIG. 6 is a block diagram of the flow of control to a plugin.

FIG. 7 is a block diagram illustrating the flow of configuration of status reading requests schedules, and the execution of the schedule.

FIG. 8 is a flow diagram illustrating the high level decision-making on the platform servers connected to the devices to support a highly scalable solution for device-to-platform connectivity.

FIG. 9 is a block diagram illustrating connection to various devices that may be located in a smart device network.

FIG. 10 is a block diagram illustrating communication with control software residing on the device.

FIG.11 illustrates the use of a common device execution interface.

FIG. 12 illustrates communication with devices having an MCU and an MPU.

FIG. 13 is a diagram of a device monitoring and control desktop.

FIG. 14 is a diagram of the data flow and operation of the desktop tool.

FIG. 15 is a diagram of the data flow and operation of the task translation subsystem of FIG. 14.

FIG. 16 illustrates the manner in which the user experience is managed with the control processing modules of FIG. 14.

FIG. 17 illustrates the operation of the execution engine of FIG. 16.

A component or a feature that is common to more than one drawing is indicated with the same reference number in each of the drawings.

### DESCRIPTION OF THE EMBODIMENTS

For clarity, device monitoring is considered strictly separate from application monitoring, and refers not to environmental data collected by sensors or peripherals, but data about the hardware device itself, and quite possibly about peripheral hardware.

In reference to embodiments shown in the figures, it is understood that examples were chosen for clarity. Single instances of an element (e.g. a device, a sensor, a server, a console, a plugin) appearing in the figures may be substituted for by a plurality of the same element, and still fall within the scope of the claims. Furthermore, it is understood that references to particular device types or configurations or manufacturers (e.g. Arduino Yun) are representative examples of any device type, configuration or manufacturer. Further yet, it is understood that references to particular communication protocols (e.g. WebSockets, HTTP, Tcp) are representative examples of protocols that enable similar network communication, such as MQTT or CoAP. In the described implementation, WebSockets is preferred for the maturity of supporting platforms and the immediacy and efficiency with which data is delivered.

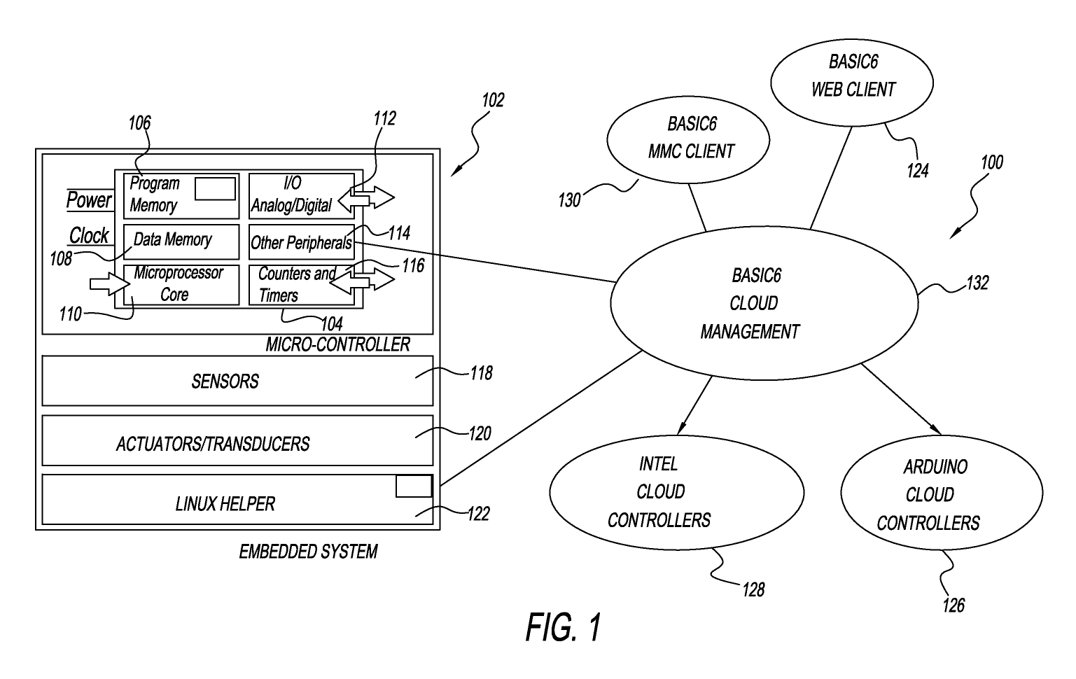

FIG. 1 displays the Basic6 Cloud Management Platform 100, with which a device 102 (represented by the “Embedded System” 104) will communicate their status, and from which the devices will be sent control signals, and from which they will receive software updates. Components of embedded system 104 include program memory 106, data memory 108, a microprocessor core 110, an analog and digital input interface 112, a peripheral interface 114 and a counter and timer module 116. Embedded system 104 is supplied with power, a clock signal, and reset and interrupt signals, as may be needed. Device 102 can be interfaced to sensors 118, actuators or transducers 120, and its own operating system helper, such as a Linux helper 122

Status of device 102 can include aspects such as memory usage, on/off status, status of peripherals etc., some of which depends on the particular device configuration, and some of which does not. Similarly, some controls will be generic (e.g. start/stop), while others will be particular to the device type (e.g. restart WiFi, re-address an iBeacon UUID).

FIG. 1 includes a web user interface, the “Basic6 Web Client” 124 whereby users may monitor and control the devices, and third party controlling systems, here by some leading hardware manufacturers for the sole purposes of discussing possible example clients, that perform similar functions. These may include Arduino cloud controllers 126, Intel cloud controllers 128 and a Basic6 MMC client 130.The “Basic6 MMC client” is a desktop based tool, that is the subject matter of U.S. provisional patent application Ser. No. 61/817,107 and U.S. utility patent application Ser. No. 14/265,146 entitled “System and Method for Managing Heterogeneous Computing Environments” It is another such client. As such, the new functionality discussed in this document extends that application's reach to control over heterogeneous devices belonging to the new IoT sphere.

To monitor and manage devices remotely requires a communication channel and device addressing once the device has been placed in the field. Such placement is typically behind firewalls that are difficult to probe from the outside, and behind routers that may re-address devices after reboots. Furthermore, moving devices may shift across WiFi networks.

Generally, secure communication connections can be established without modifications to protecting firewalls with the help of Linux Helper 122 software, for example, by using the well-known WebSockets protocol. The Basic6 MMC Client 130 is here depicted as managing devices via the Basic6 Cloud. However, alternate configurations where secure connections, in a fenced environment, to the devices can be achieved without device-resident software allow for direct connections from the desktop client to devices.

To solve the problem of establishing secure connections to and from devices in a non-fenced environment where local management of devices is outside the control of the system, the Basic6 AutoConnect feature was developed wherein on a heuristic schedule particular to the device environment (device type, network capabilities, connectivity requirements), a device 102 establishes a secure WebSocket connection to the Basic6 Cloud Management Platform 132 (generally a server) after it has been powered on. (Devices incapable of WebSocket communication can substitute https-based requests or other similar means of communication.) Subsequently, if a connection is lost, a similar schedule re-establishes the connection to the server.

Each Basic6-capable device is identified by a unique identifier, which may be partly based on the device MAC address, along with security tokens for registration, to assert the legitimacy of requests. When a device connects to a server, it delivers the unique identifier along with other data about its environment.

On the server side, the unique device identifiers are used to match the devices against the database. Initial registration of each device is carried out via a password that matches a particular device, and subsequent communication leverages the password to legitimize its control signals to the device.

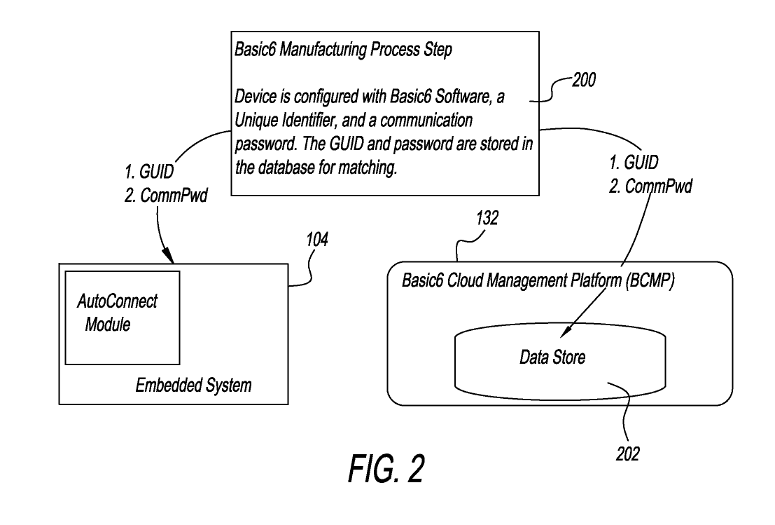

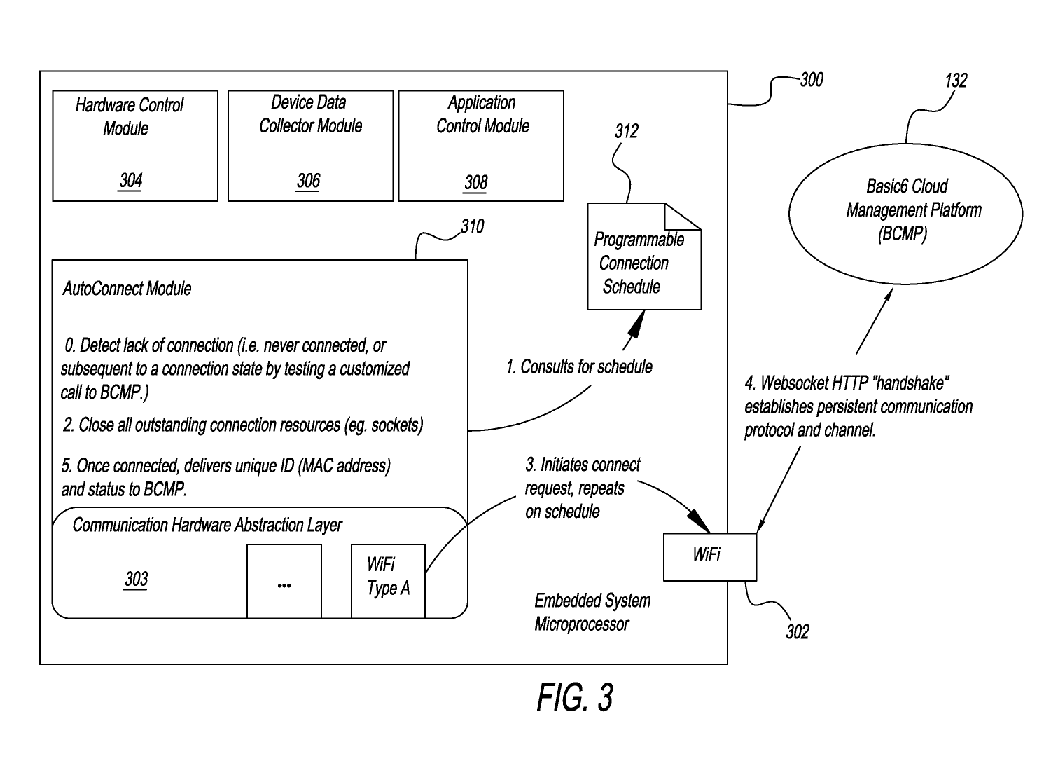

FIG. 2 demonstrates the pre-conditions for the system to work. Secure, encrypted communication for control is accepted only by the device if that communication is accompanied by the password unique to the device. As part of the manufacturing and software configuration process of a device, the password and unique identifiers are imposed on the device as well as provided to the management platform data store 202. A variation on this theme is provided for when it is not feasible to stamp unique passwords on each device during the manufacturing process; in that case a user-specific identifier given by the platform to a device owner is provided to the device by its owner. Upon an initial registration event by the device to the Cloud Platform 132, a permanent and unique password is communicated to the device by the Platform, and then persists on the device. In FIG. 3, the Basic6 AutoConnect feature is engaged whenever a lack of communication is detected; this will necessarily be the case during the initial device placement phase. Parameters to a straightforward connection attempt algorithm provide a flexible arrangement that is easily modifiable for different environmental scenarios. Typically a device will be programmed to engage in frequent attempts to connect to the platform initially, only to taper the frequency over time to reduce network strain at both ends.

In the example of FIG. 3, a WiFi module 302 and a communication hardware abstraction layer 303 are used to connect the Basic6 Cloud Management Platform 132 to a device 300. The device 300 includes AutoConnect module 310 which attempts to make a connection to Cloud Management Platform 132 based on a schedule stored in program connection schedule module 312.

Other modules included in this diagram (a hardware control module 304, a device data collector module 306 and an Application control module 308) abstract the hardware that is to be controlled. This can be an MCU, but other controlled devices can be Bluetooth emitters used for the iBeacon protocol, the WiFi itself, the embedded MPU (for instance for reboots), transducers or actuators, according to the device configuration, and from which modules data is to be collected, as well as the subsystem that passes Application control to the processor-residing program.

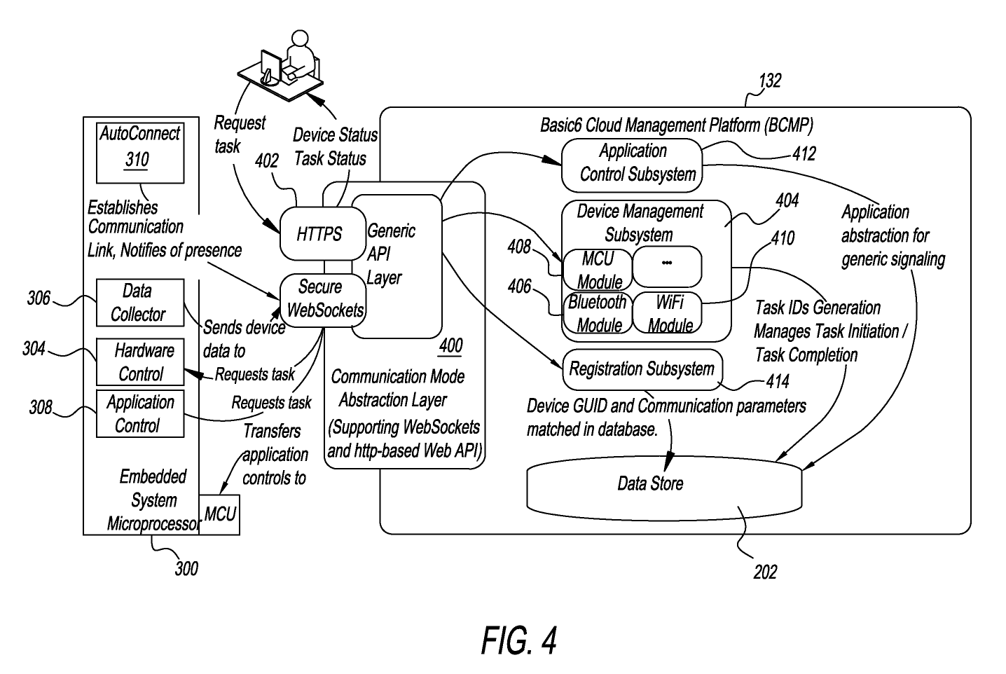

FIG. 4 shows the various subsystems involved at a high level. Here, “Application” refers to the application domain enjoyed by the device user, which is conceptually quite separate from the management of the device. The Device Management Subsystem 404 provides support for types of hardware peripheral to the processor such a Bluetooth module 406, an MCU module 408, and a WiFi module 410 as well as to the processor itself. Also present are an application control system 412 and a registration subsystem 414.

A web client is not shown in FIG. 4. However, the client may include a GUI front-end in which devices are shown and controlled heterogeneously by making calls to the Generic API layer 400 without modification via HTTPS 402, and an optional light agent on microcontrollers that delivers additional content to the microprocessor resident agent by writing data to memory on the microprocessor 300. More advanced GUI front-end clients may monitor status and exercise device control by themselves connecting to the platform with their own WebSockets connections or other protocols lending greater immediacy (“real-time”) than HTTP(s) based communication.

In order to support the many variations of device types and configurations, the System is architected to be easily extensible by separating out the generic, communication and self-managing aspects of the device-residing agent, referred to as the “Core”, from modules particular to the device configuration, referred to as “Plugins”, which can be added, subtracted, or modified for particular device configurations. Self-managing aspects of the agent include, but are not limited to, stopping, starting, suspending, and resuming agent activity, upgrading or uninstalling the agent itself, and installing new Plugins. Communication management includes the aforementioned AutoConnect feature as well as pointing the connection to a different physical server. Pointing a connection to a different server is used for load-balancing purposes pertaining to scalability, and during server upgrades.

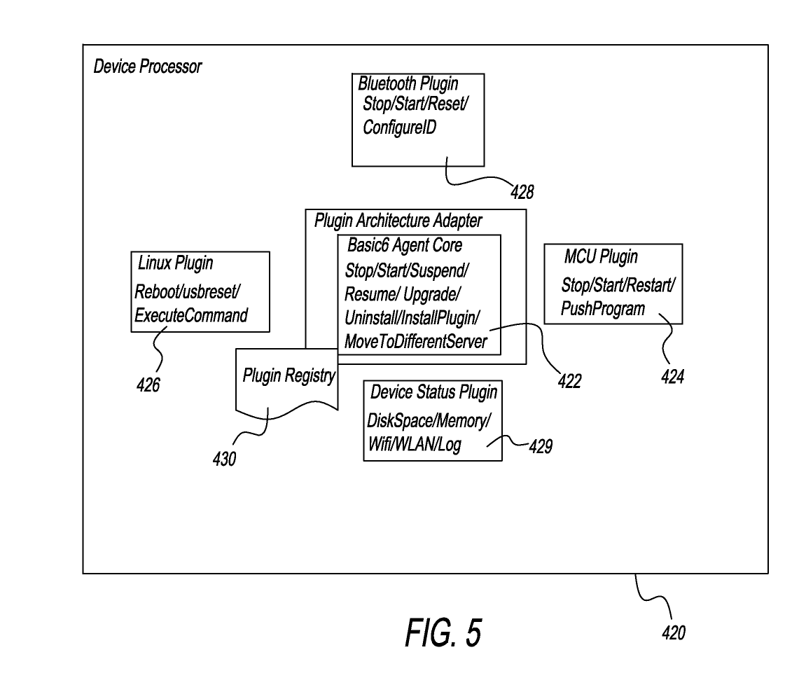

FIG. 5 exemplifies an Agent 420 including the Core 422 and a number of Plugins appropriate for the particular device in question. Here, the Core 422 is capable of the standard generic functions, while Plugins are responsible for management and status reporting of the particulars of the given device type and configuration; in this example a plugin 424 to manage an MCU peripheral to the processor on which the Agent resides, a plugin 426 to manage the underlying Linux OS, a plugin 428 to manage a Bluetooth peripheral, and a Plugin a plugin 428 dedicated to status delivery. A registry of plugins 430 is used as a source of information from which to communicate the Plugin configuration on the device to the platform, for maintenance purposes.

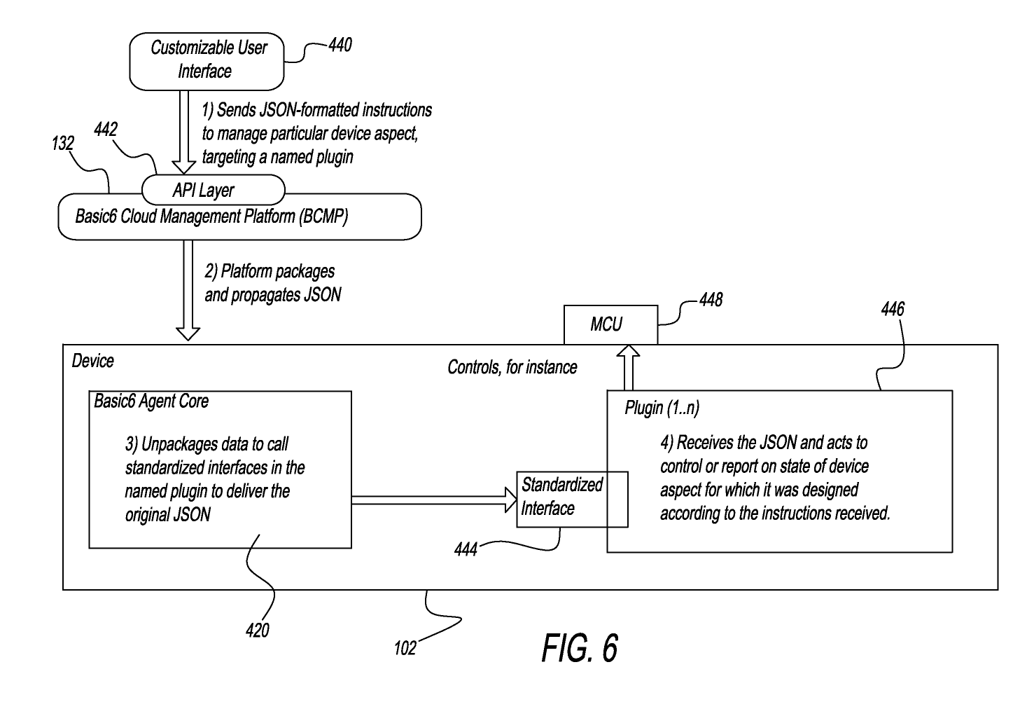

In FIG. 6, the Plugins-oriented architecture is achieved by transporting content in a packaged format from the platform particular to the heterogeneous aspects of devices in a fashion agnostic to the Core, along with an indication as to the target Plugin. The generic portion of the agent software extracts and exports the relevant package information to any number of such Plugins over standardized interfaces. Specifically, a customizable user interface 440 sends JSON-formatted instructions to an API layer 442 associated with the Basic 6 Cloud Management Platform 132 to manage a particular device aspect by targeting a named plugin. An agent core 420 of a device 102 un-packages data to call standardized interfaces in the named plugin to deliver the original JSON instruction via a standardized interface 444. The named plugin of plugins 1 . . . n 446 receives the JSON instruction and acts to control or report on the state of a selected device aspect for which it was designed, in accordance with the instruction received. For example, a selected MCU 448 can be controlled or reports on the selected device aspect.

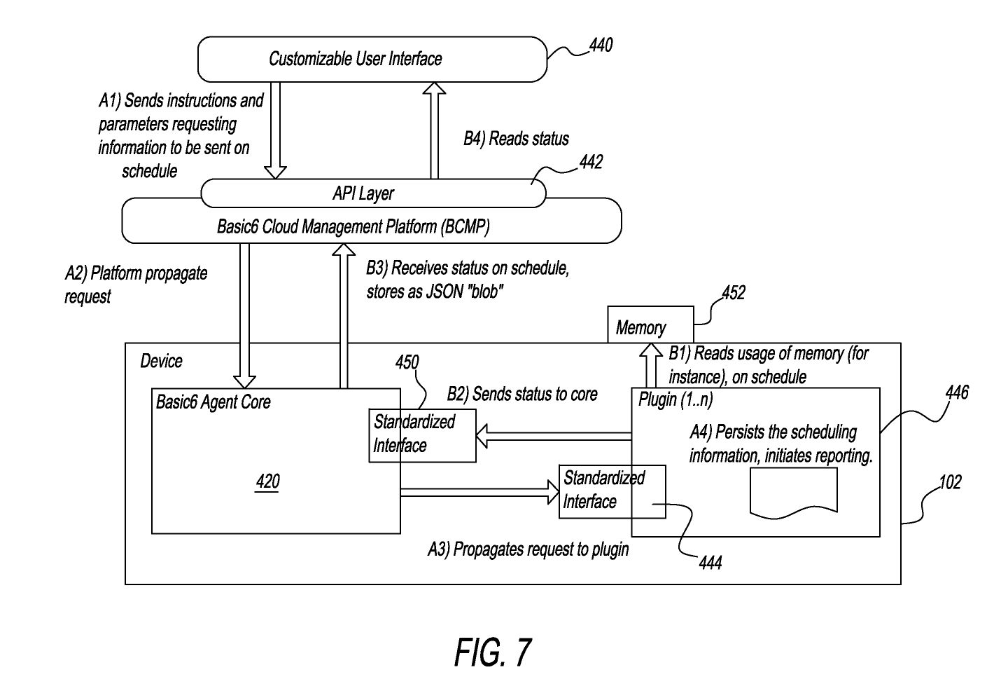

In FIG. 7, similarly, an interface accepting signals from a Plugin allow data to flow in the opposite direction on a schedule, the parameters for which are customizable for each Plugin from the platform via yet another dedicated interface method. Note that throughout, the data delivery and storage portions of the System is agnostic with respect to the nature of the information. In FIG. 7, customizable user interface 440 sends instructions and parameters requesting information to be sent on a schedule. Basic 6 Cloud Management Platform 132 propagates the request. Agent core 420 of device 102 un-packages data to call standardized interfaces in the named plugin or plugins to deliver the original instructions via standardized interface 444. The named plugins, under the instructions, can read usage of memory 452, at the schedules times. Status, such as memory usage in this example, is sent to core 420 by a second standardized interface 450. Basic 6 Cloud Management Platform 132 receives the status from core 420 on schedule. Status data may be stored in Basic 6 Cloud Management Platform 132 as a JSON “blob”.

In order to exercise the interface methods described above for multiple Plugins, each of which may take more or less time to complete a request, a controlling function in the agent Core 420 launches a new thread in an orderly fashion on which the interface method is exercised. As multiple threads may return control to Core 420 at the same time, a thread-locking mechanism is used to serialize the streaming of information returned to the Basic 6 Cloud Management Platform 132.

To support a new device, a developer can with this open and flexible architecture, create a Plugin to support a new device, or just a particular aspect of a device. The platform and the Core of the agent need not have information concerning the details or the operation of the device or that aspect. A developer may use common actions available within the existing user interface to activate and utilize functions, or create a new user interface to pass information to and from Plugins installed on a device.

The openness of the system described herein is very significant. A developer can choose to utilize any or all advantages delivered by the system described herein, while developing a Plugin that sends any or all Application-related data and functionality (for example, temperature readings, where reaching a maximum temperature, will result in triggering a notification to a user) by any other mechanism available to any other target system. In this regard, the system described herein separates not only conceptually the tasks of generic device management and control from the Application, but does so practically and physically, at the developer's discretion. The goal of this feature is to allow greater flexibility to the application developer; especially the ability to leverage cloud and other services.

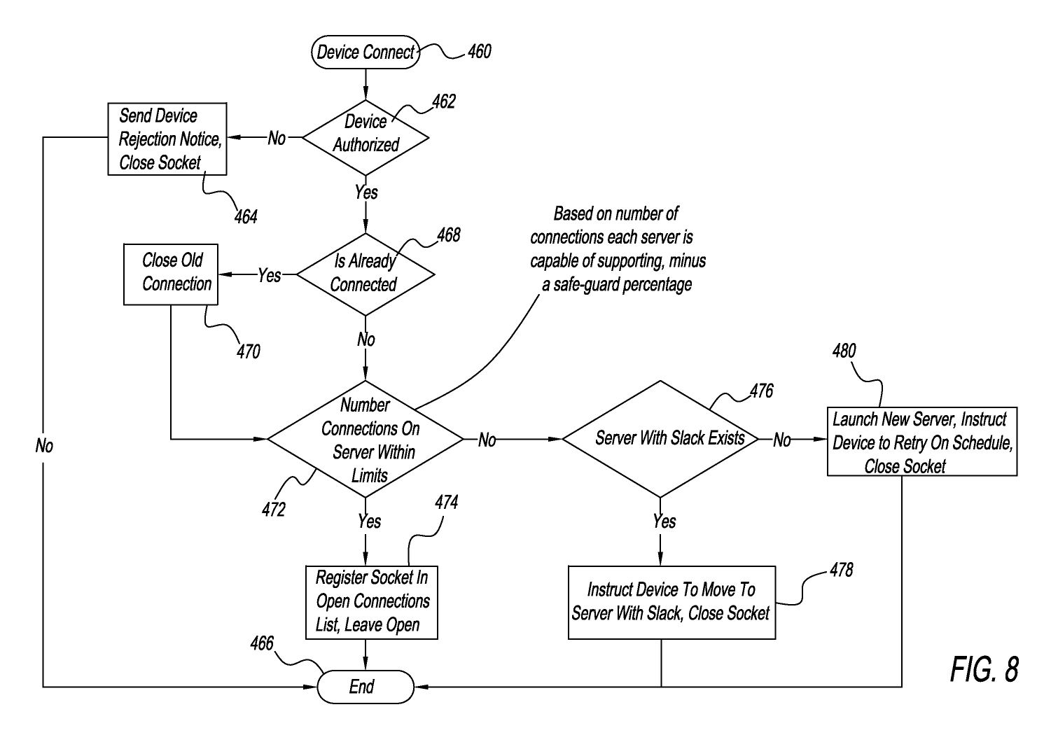

FIG. 8 exemplifies the high-level decision-making on the platform servers connected to the devices to support a greatly scalable solution for device-to-platform connectivity. The basic concept is to move the connection from the device to a different server when a server approaches testable connection limits. The underlying assumption for connected IoT devices is that once connected to the platform, they are intended to remain connected for large amounts of time, measured in days, weeks, months, rather than seconds, minutes and hours. When this is the case, any connectivity cost incurred during initialization stages will fade to near-zero levels over the life of the connection. As a consequence, the double http-based initialization sequence cost incurred when moving a WebSockets connection from one server to another becomes irrelevant. The advantages of the current concept over using a Tcp-based load balancer (in the particular case of WebSockets use) is that traffic reaches the server with one fewer intermediate stage, that networking loads can be distributed across servers and networks, and that no single point of failure is presented.

Specifically, in FIG. 8, at 460, a device is connected. At 462, a determination is made, generally as described herein, as to whether the device is authorized. If the device is not authorized, at 464, a rejection notice is sent and the connection socket for the device is closed. At 466, the process ends for that device. If, at 462, it is found that the device is authorized, at 468, a determination is made as to whether the device is already connected. If the device is already connected, at 470, the old connection is closed. In either case, flow continues to 472, where a determination is made as to whether the number of connections on a server is within a permissible limit. The permissible limit is based on the number of connections each server is capable of supporting minus a predetermined safe-guard percentage. If the number determined at 472 is within limits, at 474, the socket for the device is registered in an open connections list, and the socket remains open. At 466, the process ends for that device. If the number of connections is not within server limits, at 476, a determination is made as to whether a server that is not being fully utilized is available. Thus, at 478, the device is instructed to connect to the server that has available resources to service the device. In this case, The process ends again at 466. If at 476, no server that is not being fully utilized is available, at 480, a new server is launched, and the device is instructed to try to connect again on schedule, and the socket for the device is closed. Again, the process terminates at 466.

Any mention elsewhere of different agents assumes this design, a Core that remains constant in functionality across devices, and plugins that account for variation. However, it is understood that the actual implementation of even the Core may vary internally depending on variation in the underlying hardware and operating system.

To accomplish device monitoring, control, and software updates, the exact solution depends on the physical structure of the device, falling into two categories. The devices are most commonly based on a microcontroller, can sometimes include a microprocessor that extends the capabilities of the MCU, and are in some cases microprocessor based without an MCU.

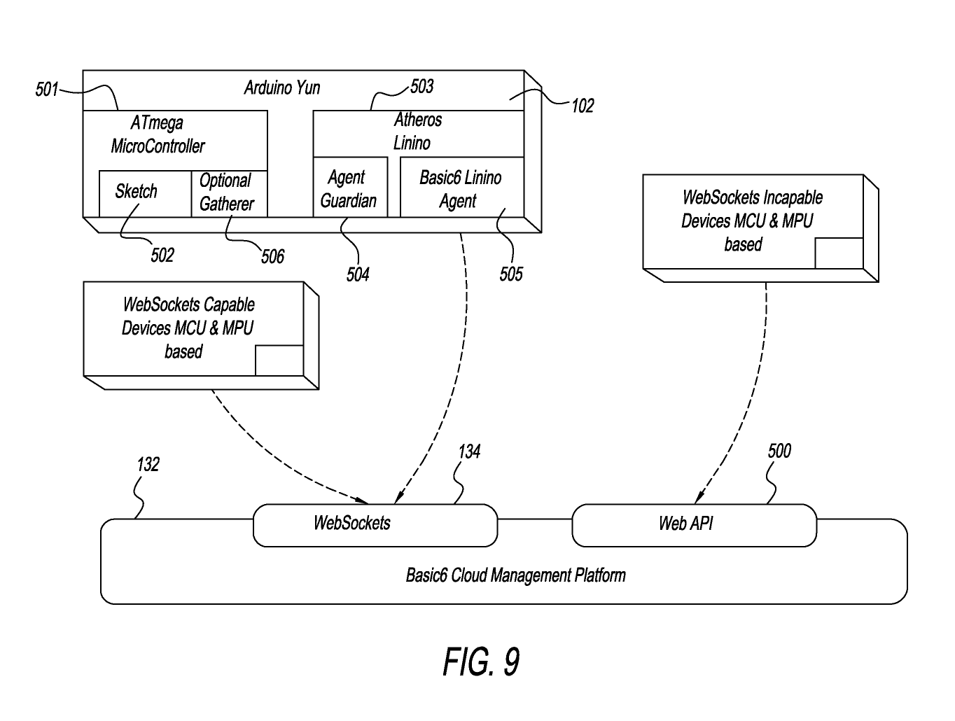

FIG. 9, illustrates the different devices, and the modes of communication they use to/from the Basic6 web-based platform 132, communicating either via https to a Web API 500, or for devices capable of it, using secure WebSockets 134. It also depicts an example of a device 102, an Arduino Yun, that is MCU based (an Atmega Microcontroller 501), running a program called a “sketch” 502 in Arduino's nomenclature), but also has an MPU 503 (on which runs a distribution of Linux called Linino). Included in FIG. 5 is an “Agent Guardian 504” which monitors the Agent 505 to ensure it is operating properly; this is not strictly essential to the system but present to insure robustness. Agent Guardian 504 will on a schedule monitor the Agent to ensure that it is loaded into memory. If it is not, it loads the Agent. Moreover, it probes it to ensure it is responsive. If not, it will restart the Agent.

An optional gatherer 506 runs on microcontroller 501. Gatherer 506 collects any device data that cannot physically be collected from the microprocessor side, and delivers it to the Basic6 Linino Agent 505 for transport to the Web application.

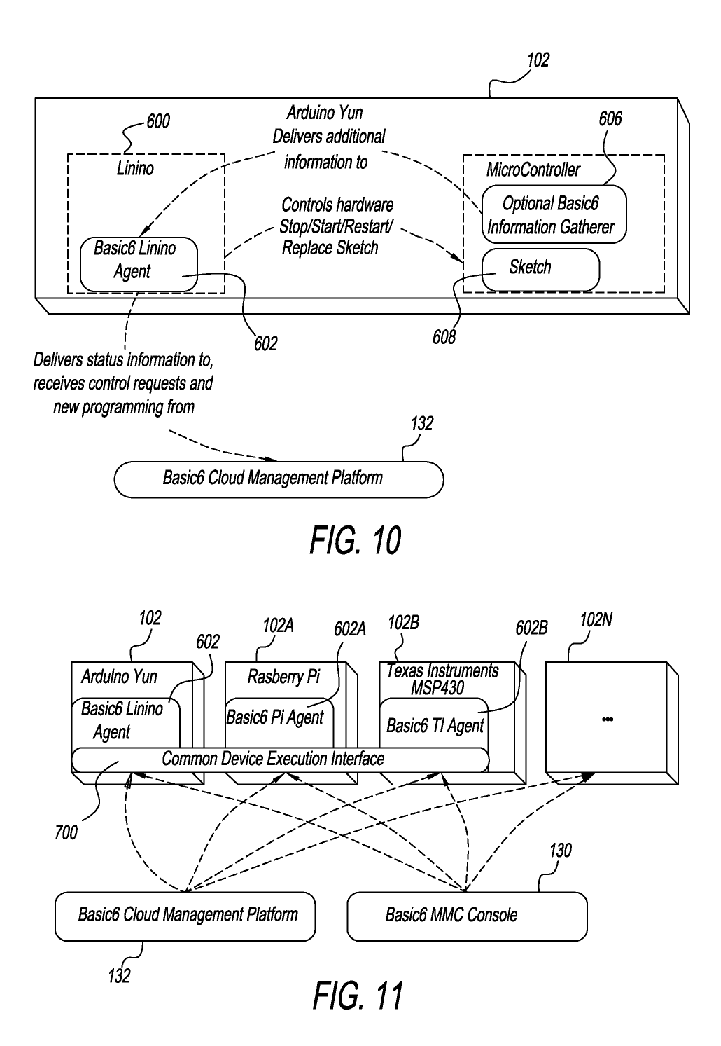

In FIG. 10, on the Yun device 102 (instead of relying on a sketch program running on the MCU, the functionality of which is extended by the Linino 600 for computing power and communication) is monitored and control is delivered via software residing on the Linino 600, called the Basic6 Linino Agent 602. The concept of Agents running on operating systems underpins some server management systems (e.g. RightScale, but not Basic6 for management of servers). However, unlike in a server context, here the Basic6 Linino Agent 602 is not software to primarily (although it can) control the MPU Linino 600 (or the chip it runs on), but is running on a peripheral of the application-driving MCU 604, and is designed to monitor and control the MCU.

To execute control, monitoring, and replacement of the current application (i.e. program running on the MCU 604), the Basic6 Linino Agent 602 uses commonly available open-source tools (e.g. Avrdude).

This mechanism is designed to leave the entire application programming unburdened by the Basic6 software, and will operate completely independent of it. This feature is available only for those sophisticated devices that include an MPU 602 in addition to the standard MCU 604.

Optionally, and not integral to the control or basic information gathering mechanisms, additional data may be delivered by the Information Gatherer 606 (a small routine incorporated within the programming of the MCU 604, in a manner similar to that of sketch 608) to memory on the Linino accessible by the Basic6 Linino Agent 602.

Other Devices.

Other devices are managed based on a similar model, with an agent residing on either the MPU that monitors and controls device hardware, or in the case of MCU-only devices is embedded within the MCU programming itself. In the MCU-only case it is recognized that the Basic6 solution will impinge on the application software. In the case of an MPU-only device, since these are already full-fledged operating systems capable of running multiple concurrent programs, there is again no overlap between application and device monitoring/control software.

Uniform Execution Interface

In FIG.11, different device types provide a common device execution interface 700, encapsulated within each agent, whereby controls can be delivered from the platform in a uniform manner. Note that this is a logical common interface, residing in each Agent implementation, not a physical one. Control can be exercised on devices on a local network by the desktop console 130, or for any internet-connected device via the cloud platform. Such devices include the Yun device 102, Raspberry Pi device 102A, Texas Instruments MSP430, and any other device including up to device 102N. It is also possible, as is the case for the Basic6 Cloud Management Platform 132, for any third party user interface capable of accessing the Platform's API 442 to aggregate device information.

Application Control

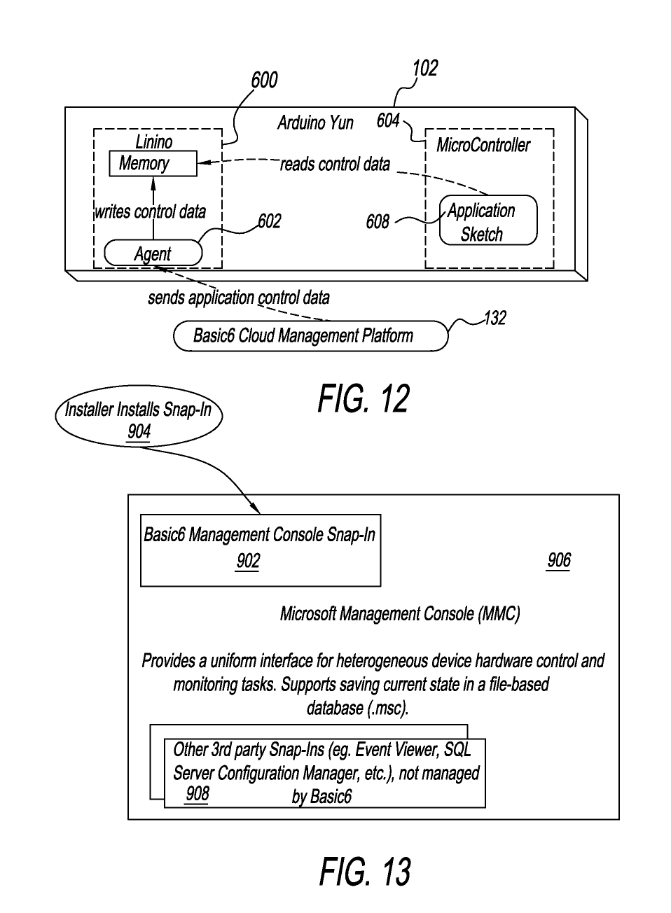

In FIG. 12, for devices having an MCU and an MPU—leveraging the communication channel established between the devices and the Basic6 Platform 132, application-level controls and status requests can via the Web API shown deliver control data to memory dedicated on the MPU 600 for the purpose of being read by the program running on the microcontroller 604, via an appropriate Plugin. This is shown in FIG. 12, with the Yun device 102 as an example. A logical extension of this example is to deliver control data to devices connected to the platform-connected (“gateway”) device in any connection formation via yet another Plugin, without other modifications to the system described herein.

Device Monitoring and Control Desktop

Referring to FIG. 13, a desktop tool manages IoT devices to which a direct connection can be made, whether directly connected, or over a local WiFi, alternately with a virtual private network (VPN) to allow remote access over the internet. The executable loads as a snap-in to the MMC console, allowing for a commonly understood user interface paradigm for administrators. In the context of the desktop tool, the devices are in addition required to host a microprocessor through which commands can be processed to inspect and manage the various aspects of the device, especially a microcontroller, but also other hardware aspects such as Bluetooth emitters and WiFi chips, and the microprocessor itself, and any memory associated with the MCU or MPU. The general purpose of the tool is to allow heterogeneous control of a variety of devices from a common interface, and/or of multiple devices of the same type, without requiring installation of any additional agents.

In FIG. 13, in a preferred embodiment, the apparatus and method disclosed herein can be implemented by a snap-in software component 902 that is installed 904 in a Microsoft Management Console (MMC) 906. Other snap-ins 908 may include an event viewer, and an SQL Server configuration manager, and others well known in the art. When installation is complete, a desktop icon is provided, that when clicked, opens a pre-configured (Basic6 snap-in) MMC console, as discussed below.

Unlike in the Web Application context, the Microprocessor (MPU) does not carry an agent in this context, for which abstractions required to provide a uniform interface are made on the snap-in side. Devices come in different hardware configurations, each with their disparate control and reporting capabilities, of common hardware capabilities such as WiFi, Bluetooth emitters, and Microcontrollers (MCU). Depending on the particular subtype of such hardware, such as the particular type of MCU, different commands are required from Unix-based devices to manage them. These variations are abstracted within the desktop software, as are variations in the MPU operating systems.

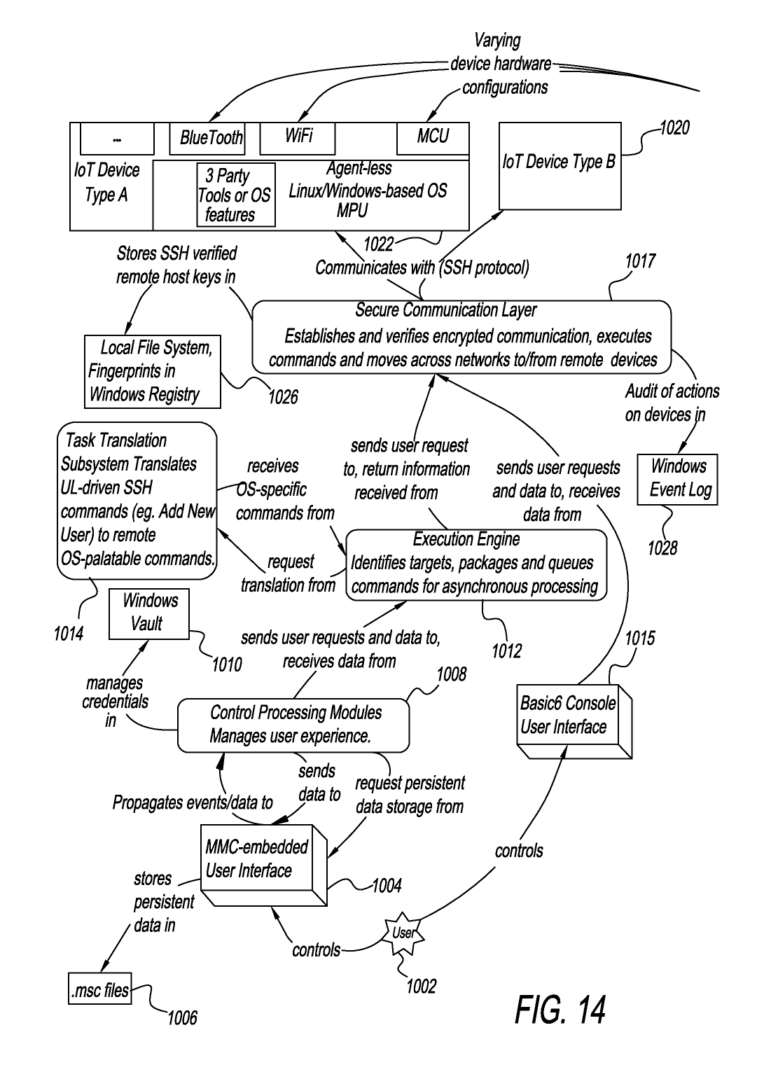

FIG. 14 provides an overview of the operation of the desktop tool. Important to note here is that unlike the web application-based system, where communication is sometimes initiated from the device-side, requests for control and data are in this context always initiated from the desktop tool side. This is because the system here is “agent-less”, which significantly reduces the need for prior device configuration and registration during deployment. Features of the operating system are used to manage the devices, and sometimes third party open-source tools dedicated to these purposes, such as AvrDude that can be used to stop/start or change the programming on the MCU residing on an Arduino Yun device. Such tools are typically included in the distribution of the device out of the box, but when that is not the case, they would need to be installed on the device prior to use with Basic6; this is the only setup required, beyond ensuring that communication is possible with the MCP of the device.

In FIG. 14, a user 1002 logs into a computer account, thus establishing a user identity. The user does so with an MMC-embedded User Interface 1004 which saves and stores user configurations/paths to devices as .msc files in a persistent data file storage area 1006. The .msc files can be re-opened and shared amongst multiple users. A logged on Windows ID is required for Single Sign on (SSO) access to the end user desktop/server on which the .msc file is opened.

A user who has logged in selects a device having a particular operating system and adds his user ID and specifies other parameters. The user requests action to be started to control or monitor the selected remote device, or to manage the contents of the operating system itself. The user entered parameters are enhanced with any predefined device specific user creation template information. This is done with the Control Processing Modules 1008 which manage the user experience by enabling the access and marriage of the MMC (saved devices) and the Windows Vault 1010, which is used as the credential repository for device access. In other words the saved MMC (.msc file) provides cached device connectivity information (DNS, IP address) with the Windows Vault 1010 acting as the store for credentials which allow for the access to this information. Credential information (UID, pwd, SSH private key file location) is retrieved from vault 1010.

Once access has been granted to a remote device in either a data center or in the cloud, action requests are sent to an Execution Engine 1012, which under the covers identifies the target, packages and queues the console commands for asynchronous processing. All commands flow through a Task Translation Subsystem 1014 that queries the target and identifies the specific native commands that execute versus the OS.

All command issuance, from console user interface 1015, follows secure communications protocol. This underlying Secure Communication Layer 1017 is comprised of secure calls to target systems utilizing the SSH protocol (for connection to Internal Network, Internet (External, including non API Cloud) in conjunction with SDKs used for connection to agent-less devices 1022 and 1020, of heterogeneous types. The secure Windows Registry 1026 is used as the repository for all SSH verified remote host finger prints, and the file system for the keys themselves, for communication with Internal Network, External, and Cloud servers. It is this persistent data storage that is called upon within the Control Processing Modules 1008 connectivity request.

Execution engine 1012 queues the sequence of requests. Device “fingerprint” information is retrieved from Windows Registry 1026.

All commands issuance by console user interface 1015 are captured within the Windows Event Log 1028. This provides a full audit of actions executed on remote devices replete with native command issuance, executing user information that includes Windows identification and the computer of action issuance.

Task Translation Subsystem

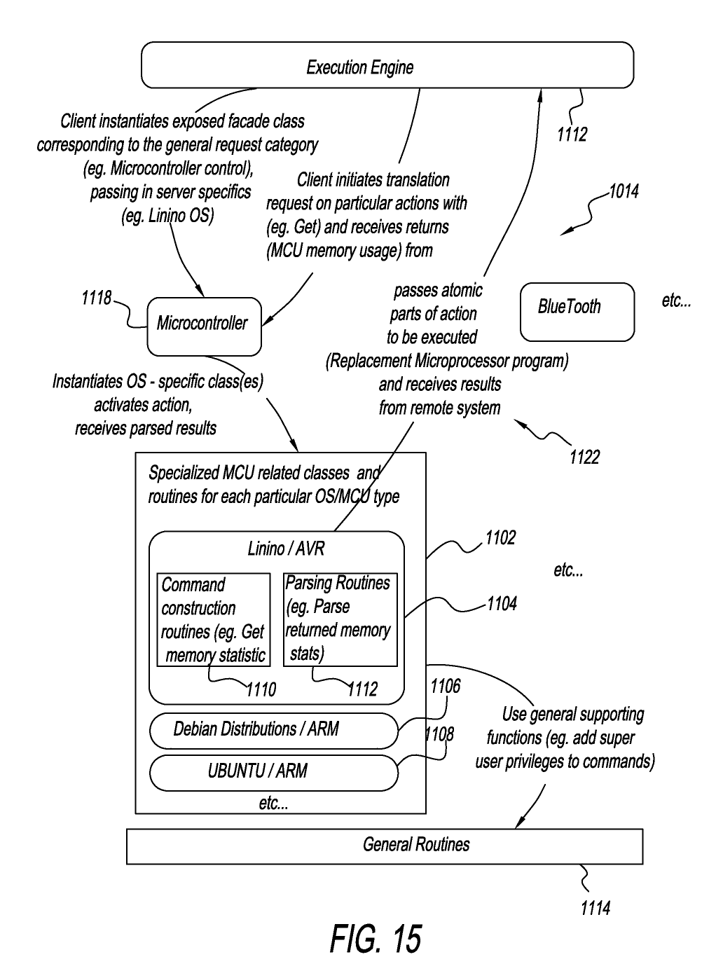

FIG. 15 illustrates the structure and function of the task translation subsystem 1014 for abstracting these variations away so that device control can be presented in a uniform manner. Here, the particular operating system (e g Linino) that the desktop connects to requires particular commands to manage the particular type of hardware aspect (e.g. an MCU of the AVR variety) within the same device.

In FIG. 15 task translation subsystem 1014 accesses specialized account, group and file related classes and routines (with more to be added), including create, delete and edit files, reboot the system, control associated hardware such as a Bluetooth emitter with stop/start/reconfigure UUID commands, or a microcontroller with stop/start/restart/update program commands, at 1102 for each operating system such as, for example, Linino/AVR 1104, Debian Distributions/ARM 1106, UBUNTU 1108 and many others. Each account will have operating system specific command construction routines 1110 and instruction parsing routines 1112. Specialized account related classes and routines 1102 also has access to general routines 1114 which perform general functionality such as adding security related decorations to commands.

A microcontroller 1118 instantiates the operating system for a specific class or classes, activates various actions and receives parsed results. In addition to individual accounts, groups and file system management microcontroller 1118 initiates the operating system-specific class or classes.

At 1122, task translation subsystem 1014 (FIG. 10) parses atomic parts of an action to be executed from the account being used. Further, results can be received from a remote system via execution engine 1112. For example the user may instantiate an exposed facade class corresponding to the general request category (e.g. Stop MCU), in server specifics, such as in the Solaris operating system. The user may also initiate translation requests on particular actions (e.g. Get) and receive returns (Action responses) from the remote system via execution engine 1312.

Control Processing Modules

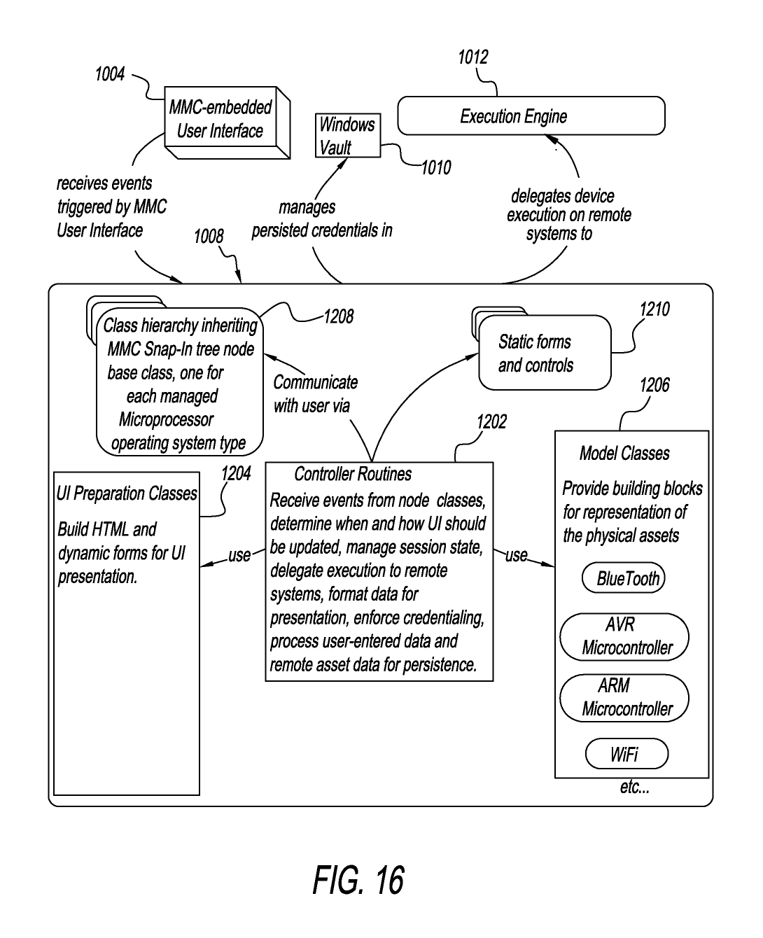

FIG. 16 demonstrates how, with Control Processing Modules 1008 (FIG. 10), the user experience is managed, allowing devices with heterogeneous operating systems and differing physical device configurations to be managed side-by-side, and have operations performed in bulk. An example, is replacing the current programs running on multiple Arduino Yun and Arduino Tre devices with an upgrade of their software.

Thus, FIG. 16 illustrates the structure and function of the control processing subsystem 1008. Control processing subsystem 1008 receives events triggered by the MMC embedded user interface 1004 and manages persistent credentials in Windows vault 1010. Controller routines 1202 in control processing subsystem 1008 receive events from node classes, determine when and how the user interface should be updated, manage session state, delegate execution two remote systems, format data for presentation, force credentialing, process user entered data and remote asset data for persistence. Control processing subsystem 1008 delegates execution on remote systems to execution engine 1012.

Controller routines 1202 use user interface preparation classes 1204 to build HTML and dynamic forms for user interface presentation. Controller routines 1202 also use model classes 1206 to provide building blocks for each device instance physical assets such as Bluetooth emitter, MCU, WiFi chip, and other functions. Controller routines 1202 communicate with the user via a class hierarchy 1208 which inherits MMC snap-in tree node base classes (one for each managed virtual infrastructure asset type). Communication is also accomplished via static forms and controls 1210.

Execution Engine

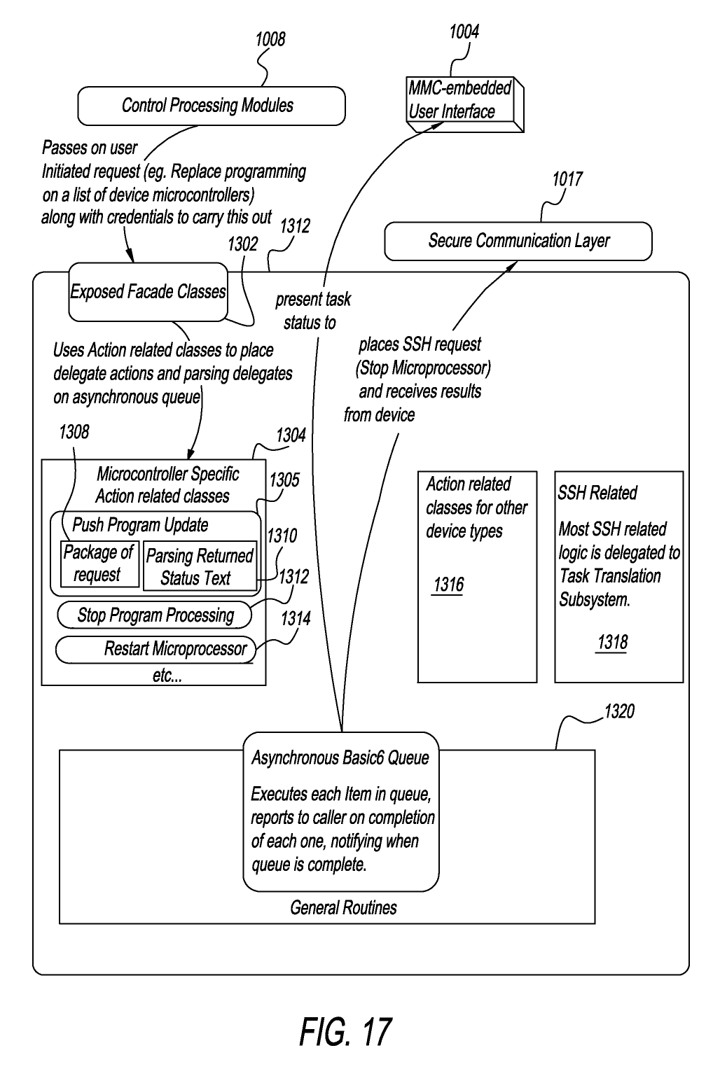

In FIG. 17, the inner workings of the execution engine 1012 (FIG. 10) are shown. The types of targets are identified, placed on a queue for asynchronous processing, and reports are made to the user interface.

Referring to FIG. 17, the execution engine subsystem 1312 receives user initiated requests from control processing modules 1008. These requests can include the rebooting of a list of devices as set forth herein. This information is passed to exposed facade classes 1302. Action related classes are used to place delegated actions and parsing on an asynchronous queue. Microcontroller specific action related classes are available at 1304. Program updates that can be pushed to devices are available at 1305. Packaging of a request is done at 1308. Parsing of returned status text is accomplished at 1310. Device type specific action related classes include stopping program processing at 1312 and reboot of the microprocessor at 1314. Routines are available for packaging of a request 1308 and for parsing returned information 1310. Other classes include stop server 1312 and create image 1314, as well as numerous others.

Action related classes for providers other than AWS are available in 1316. While most SSH related logic is delegated to task translation subsystem 1014, any additional SSH related logic is found at 1318. General routines 1320 deal with the asynchronous queue. Specifically, each item in the queue is executed, reports are sent to the caller on completion of each item, and the caller is notified when all commands in the queue have been completed. These commands can include placing requests such as rebooting of the device. Results from the remote device can be received.

It will be understood that the disclosure may be embodied in a computer readable non-transitory storage medium storing instructions of a computer program which when executed by a computer system results in performance of steps of the method described herein. Such storage media may include any of those mentioned in the description above.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof.

What is claimed is:

1. A device comprising:
a processor;
at least one interface for the device to interact with apparatus in the environment in which the device is located, the at least one interface being connected to the processor to send a signal to or receive signals from the processor;
memory associated with the processor having a first program or programs for operating the processor and application-related activities and a second program for performing operations related to the state of the device; and
a network connection for connecting the device to a network so that operations relating to the state of the device can be remotely performed using the network.

2. The device of claim 1, wherein the processor is a microprocessor, and communication with the device via the network is with the microprocessor.

3. The device of claim 1, wherein the processor is a microcontroller, and communication with the device via the network is with the microcontroller.

4. The device of claim 1, wherein the processor comprises one of:
a microprocessor for running programs;
a microcontroller for running programs; and
a microprocessor and a microcontroller for running programs

5. The device of claim 1, wherein the at least one interface is for connection to at least one of a sensor, an actuator and a transducer.

6. The device of claim 1, wherein the second program facilitates an operation selected from the group consisting of configuring a program in the memory, replacing a program in the memory, changing the state of the processor, sending updates responsive to communication protocol changes, recording access credentials for interacting with the device, and changing the state of device components peripheral to the processor.

7. The device of claim 1, wherein the second program facilitates an operation of changing the state of device components peripheral to the processor, wherein the peripheral device components include at least one of communication-related hardware, actuators, sensors, transducers, microprocessors, and microcontrollers.

8. The device of claim 1, wherein the second program facilitates an operation of changing the state of device components peripheral to the processor, wherein the peripheral device components include a mesh of devices connected to a platform-connected device.

9. The device of claim 8, wherein the peripheral device components are not directly connected to the platform.

10. A system for interacting with the device of claim 1, comprising:
a task input subsystem for a user to input a task to be performed on the device;
a task translation subsystem for translating the task into a language usable by the device; and
a communications module for the system to use in communicating the task to the device via the network.

11. The device of claim 1, configured so as to allow homogenous management via a common interface of a plurality of devices of heterogeneous construction.

12. The device of claim 1, configured as an open system for management of a plurality of devices having different operating systems.

13. A method for managing operation of a device having a processor and at least one interface for the device to interact with apparatus in the environment in which the device is located, the at least one interface being connected to the processor to send a signal to or receive signals from the processor; comprising:
accessing in the memory of the device a program for interacting with the processor, the program performing operations related to the state of the device; and
sending tasks relating to the state of the device to the processor so that the operation of the device is managed.

14. The method of claim 13, further comprising using a common interface for management of a plurality of devices of heterogeneous construction.

15. The method of claim 13, further comprising installing the program in the memory of the device.

16. The method of claim 13, wherein the device includes a network communication module; and sending of tasks is performed using a network to which the communications module is connected.
